(19) United States
(12) Patent Application Publication
(10) Pub. No.: US 2008/0099946 A1
(43) Pub. Date: May 1, 2008

(54) Foam for mitigation of flow assurance issues in oil & gas systems

(75) Inventors: Gene E. Kouba, Katy, TX (US); Alberto Montesi, Houston, TX (US); Lee D. Rhyne, Cypress, TX (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Chevron U.S.A. Inc., San Ramon, CA (US)

(21) Appl. No.: 11/590,182

(22) Filed: Oct. 31, 2006

(51) Int. Cl. C08J 9/00

(52) U.S. Cl. 264/51; 521/50

(57) ABSTRACT

The present invention is generally directed to methods and systems for mitigating flow assurance issues that arise in the pipe transport of hydrocarbon fluids, particularly wherein such hydrocarbon fluids are gas-dominated. Generally, such methods and systems rely on the formation and subsequent transport of a foam through an associated transport pipe.

### FIELD OF THE INVENTION

This invention relates generally to oil and gas flow assurance issues, and specifically to methods and systems for improving flow characteristics in a hydrocarbon fluid pipeline via the formation of foam.

### BACKGROUND OF THE INVENTION

### Flow Assurance

Flow assurance is of considerable importance in the transport of hydrocarbon-based fluids through pipelines. Flow assurance issues include deposits (e.g., asphaltene, wax, hydrates, etc.) and, particularly in the case of gas-dominated hydrocarbon fluids, slippage between the gas phase and the liquid phase. Such latter issues are at least partially responsible for pressure losses and severe slugging problems, and they can contribute to sand deposition.

While no universal method exists in the art for comprehensively addressing all of the above-listed flow assurance issues, methods have been developed that partially address these issues. For example, “pigging” is used to clean and inspect pipelines. Additionally, surfactants have been used to reduce slugging (see, e.g., Kolpak et al., U.S. Pat. No. 5,564,456). These methods, however, only partially address the flow assurance problems and/or require complete or partial shutdown of the system-thereby reducing overall efficiency.

### Foams

The flow of foams through pipes has been well established. See, e.g., Briceño et al., “Self-lubricated transport of aqueous foams in horizontal conduits,” Int. Journal of Multiphase Flow, vol. 29, pp. 1817-1831, 2003; Calvert, “Pressure drop for foam flow through pipes,” Int. Journal of Heat and Fluid Flow, vol. 11(3), p. 236, 1990; Calvert et al., “A rheological model for a liquid-gas foam,” Int. Journal of Heat and Fluid Flow, vol. 7(3), p. 164, 1986; Wiggers et al., “The flow of foam films in vertical tubes,” Trans. of the Inst. of Chem. Engineers, vol. 78, pp. 773-778, 2000. Additionally, Chartier et al., U.S. Pat. No. 6,841,125 describes a method for cleaning and applying foamed corrosion inhibitor to ferrous surfaces with an emphasis on fire protection systems (e.g., sprinkler systems). While foam has been used in the petroleum industry to aid removal of water in low pressure gas wells and to reduce the hydrostatic head of drilling mud below the fracture gradient while retaining ability to remove cuttings, Applicants are unaware of any application of foam for mitigating flow assurance issues in production pipelines.

In view of the foregoing, methods for mitigating such above-described flow assurance issues with the use of foams (i.e., foam flow methods) would be extremely useful—particularly wherein such methods favor uniform flow and reduced pressure losses, eliminate slugging problems, reduce liquid inventory, and improve the application of a variety of chemical treatments and/or additives.

### BRIEF DESCRIPTION OF THE INVENTION

The present invention is generally directed to methods and systems for mitigating flow assurance issues that arise in the pipe transport of hydrocarbon fluids (see above). Generally, such methods and systems rely on the formation and subsequent transport of a foam through the associated transport pipe or pipeline.

In some embodiments, the present invention is directed to methods comprising the steps of: (a) generating a foam that is either an oil-based (hydrocarbon-based) foam and/or a water-based foam; (b) transporting said foam a distance through a transport pipe, wherein the transport pipe is used for hydrocarbon fluids; and (c) de-foaming said foam subsequent to it being transported. Typically, such hydrocarbon fluids are gas-dominated, but in some embodiments they can be liquid-dominated.

In some such method embodiments, the transport pipe can be completely or only partially filled with foam, depending on the specific properties and conditions of the associated application. Completely filled pipe ensures a homogeneous plug flow regime along the line, whereas intermittent foam plugs can sweep liquid from the pipeline more efficiently than gas alone, thereby resulting in less liquid inventory in the pipeline and lower pressure loss. Furthermore, a partially-filled pipe modifies the flow map of the system—thereby increasing the apparent volume of liquid in the pipe.

In start-up operations, formation of foam can permit a more effective removal of condensate that may have accumulated along the pipeline. Additionally, in shut-down operation, foaming can allow for uniform dispersion and mixing of any inhibitor necessary for a particular application/process.

In some embodiments, the present invention is directed to systems for transporting foam through a transport pipe, i.e., systems for implementing the above-described methods, the systems comprising: (a) a transport pipe for transporting hydrocarbon fluids (e.g., gas-dominated hydrocarbon fluids); (b) a means for generating a foam, wherein the foam is either a hydrocarbon-based foam or a water-based foam; (c) a means for transporting said foam a distance through the transport pipe; and (d) a means for destabilizing or “breaking” the foam subsequent to it being transported through the transport pipe.

Such above-described methods and systems generally provide for substantial improvement over existing methods for providing flow assurance, particularly with respect to the pipe transport of gas-dominated hydrocarbon fluids and their more universal applicability in addressing flow assurance issues.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts, in stepwise fashion, the foam-flow process, in accordance with some embodiments of the present invention;

FIG. 2 depicts, in flow diagram form, a fairly generic system for carrying out the foam-flow process, in accordance with some embodiments of the present invention;

FIG. 3 depicts a system used for implementing the foam-flow process wherein the step of foaming is carried out in situ; and

FIG. 4 depicts a system used for implementing the foam-flow process wherein the step of foaming is carried out in an auxiliary side stream.

### DETAILED DESCRIPTION OF THE INVENTION

As mentioned above, the present invention is generally directed to methods and systems for mitigating flow assurance issues (e.g., the formation of slugs) that arise in the pipe transport of hydrocarbon fluids. Generally, such methods and systems rely on the formation and subsequent transport of a foam through the associated transport pipe.

The term “fluid,” as defined herein, refers to a substance (as a liquid and/or gas) tending to flow or conform to the outline or confines of its container and which is amenable to flow.

The term “gas-dominated,” as defined herein, refers to fluids having their flow dominated by the gas dynamics or flow. Typically, this involves fluids wherein gas comprises at least 20% of the volume of the fluid. Conversely, a “liquid-dominated” fluid is one wherein the flow of said fluid is dominated by the liquid component.

The term “foam” or “a foam,” as defined herein, refers to a substance, such as a fluid, that is formed by trapping a plurality of gas bubbles within the substance's matrix. Such foam fluids can be considered to be a suspension formed by a continuous liquid phase and a discontinuous gas phase (i.e., the bubbles).

### Process Embodiments

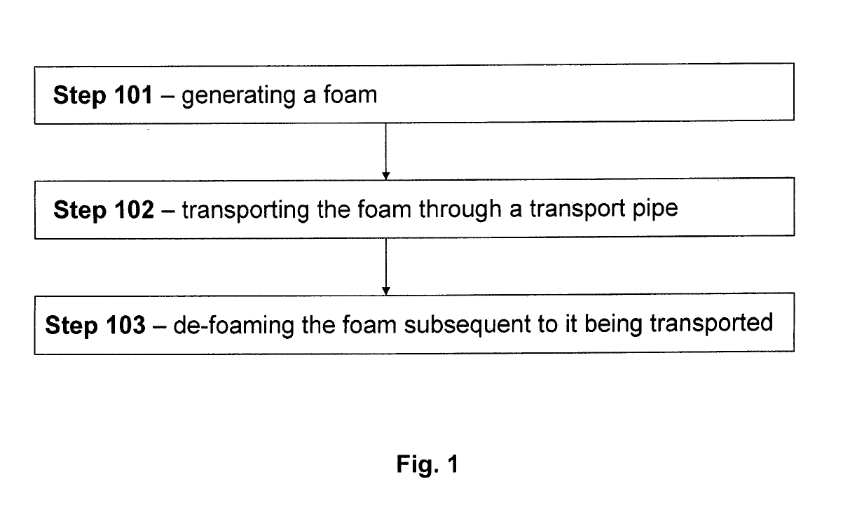

Referring to FIG. 1, in some embodiments, the present invention is directed to methods comprising the steps of: (Step 101) generating a foam selected from the group consisting of an oil-based foam and/or a water-based foam; (Step 102) transporting said foam a distance through a transport pipe, wherein the transport pipe is used for transporting hydrocarbon fluids; and (Step 103) de-foaming said foam subsequent to it being transported. Such methods are generally representative of the “foam flow process” presented herein. Moreover, the hydrocarbon fluids so transported are typically gas-dominated.

Generally, the foam is generated from foam precursor(s). In some presently-contemplated embodiments, the foam comprises the hydrocarbon fluid that the pipe transports. That is, the hydrocarbon fluid serves as a foam precursor. In some such embodiments, all or part of the hydrocarbon fluid is at least partially transported as a foam within the associated pipeline.

In some such above-described foam flow processes or methods, the step of generating a foam (i.e., foaming) and/or the step of de-foaming said foam is done in-line or in situ. In some or other embodiments, the foaming and/or de-foaming steps are performed in an auxiliary side stream and introduced to the main stream subsequent to foaming and/or removed prior to de-foaming.

In some embodiments, the step of generating a foam comprises passage of pre-foamed components through regions of pipe providing turbulent flow. In some or other embodiments, the step of generating a foam comprises turbulent (e.g., mechanical or hydraulic) agitation. In some or still other embodiments, the step of generating a foam utilizes a foaming agent such as, but not limited to, surfactants, surface active agents, foamers, soaps, solid particles, and the like. Exemplary such foaming agents include, but are not limited to, sulfonates, amines, alcohols, and the like. In all such embodiments, the foaming can be done either continuously or intermittently.

In some such above-described method embodiments, additives are introduced during the step of generating a foam. In some such embodiments, such additives include, but are not limited to, one or more of the following: corrosion inhibitors, drag reducing agents, hydrate inhibitors, and similar such species. In some such embodiments, the foam enhances the distribution and application of such additives within the transport pipe.

With regard to the step of de-foaming or destabilizing the foam, this step can involve an active and/or passive sub-process. That is, steps can be taken to actively break the foam, or the foam can be allowed to break on its own.

### System Embodiments

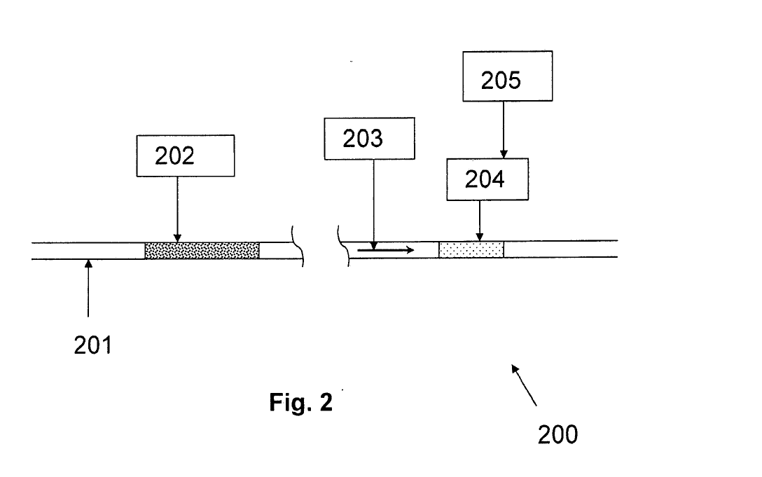

Referring to FIG. 2, illustrating generic system 200, in some embodiments, the present invention is generically directed to systems for transporting foam through a transport pipe, the systems comprising: a transport pipe (201) for transporting hydrocarbon fluids; a means (202) for generating a foam selected from the group consisting of a hydrocarbon-based foam, a water-based foam, and combinations thereof; a means (203) for transporting said foam a distance through the transport pipe; and a means (204) for breaking the foam from the transport pipe subsequent to it being transported. As with the method embodiments above, such hydrocarbon fluids transported with the system are commonly gas-dominated.

Corresponding to related method embodiments, in some such system embodiments, the foam generation (i.e., the foaming provided by means 202) can be carried out either in situ or in a side stream. In the latter case, such a side stream is typically in fluid communication with the transport pipe. Additionally, there is typically a means for introducing said foam into the transport pipe 201, wherein such a means is typically an injector. In all such embodiments, the foaming can be done either continuously or intermittently.

In some such above-described system embodiments, the means 202 for generating a foam comprises agitation selected from the group consisting of mechanical mixing, turbulent flow, and combinations thereof. Accordingly, in some such embodiments a mechanical mixer and/or regions of pipe for introducing turbulent flow are integrated into the system. Regions suitable for inducing turbulent flow include, but are not limited to, vertical flow in a well-bore or riser; flow through a mixer, valve, choke, and/or pump; and flow through appropriately-sized restrictions. In some or other embodiments, the means for generating a foam comprises the addition of a foaming agent such as, but not limited to, surfactants, surface active agents, foamers, soaps, solid particles, and the like.

As mentioned above, in some embodiments system 200 comprises a foam introduction means. The foaming agent may be introduced to the multiphase stream by any of the following: neat or diluted injection directly into multiphase stream, neat or diluted injection into a separated side stream of liquid or gas, neat or diluted injection with additional injection gas, or as a pre-mixed concentrated foam.

In some embodiments, the above-described system further comprises an optional means (205) of introducing additives to the foam. Typical such additives include, but are not limited to, one or more of the following: corrosion inhibitors, drag reducing agents, hydrate inhibitors, and similar such species.

In some embodiments, the means 204 for removing the foam comprises de-foaming, which may include addition of a de-foaming agent (e.g., a silicone species like polydimethylsiloxane). Like the foaming, this de-foaming can be done in the transport pipe 201 or in an auxiliary side stream subsequent to transporting the foam through the pipe. Subsequent to transport, the foam may be destabilized or otherwise de-foamed through application of one or more of the following: dilution, chemical de-foaming agent(s), heat, mechanical forces (e.g., shear and body forces through nozzles, stirrers, cyclonic flow, etc.).

In some of the above-described system embodiments, system 200 further comprises a means of monitoring the foam formation and quality. Such monitoring may include, but is not limited to, monitoring of the following: density, pressure gradient, electrical characterization (e.g., resistance), complex dielectric, etc.

Numerous embodiments and variations on said embodiments exist with respect to the above-described processes and systems. To summarize, such methods can comprise either an oil-based or water-based foam, generated via a variety of ways either in situ or in a side stream, and the foaming/de-foaming can be either continuous or intermittent. All such methods, however, involve transporting the foam through pipe which is used for the transport of fluids comprising hydrocarbons and/or water produced from a production system. In some embodiments, such foams comprise both the hydrocarbon fluid and the water. Furthermore, the step of de-foaming may be optional. Similarly, the above-described systems can be adapted for implementing any of these aforementioned method embodiments.

### Advantages

Advantages of foam flow in the pipe transfer of hydrocarbon fluids are many. Some such advantages are described below.

In some embodiments, the foam-flow process will flush accumulated liquid from the associated pipeline. Since this liquid is commonly water-rich, the use of corrosion inhibitors and their corresponding application procedures can be reduced or even eliminated. In some cases, this “flushing” would reduce or even eliminate the need for pigging (aka “sphering”) the pipeline and avoid the associated upset in production. Additionally, the need for looped pigging lines may be eliminated.

Similar to the flushing described above, the foam-flow process will generally be more efficient at reducing sand depositions and removing sand from the pipeline. As in the above-mentioned cases, this also results in a reduction of pigging operations and associated facilities.

In some embodiments, upstream foam generation can eliminate severe slugging in risers and dramatically reduce fluctuations in flow rate to downstream equipment such as multiphase pumps, separators, etc. This means that simpler, more compact systems may be used to process the fluids, since capabilities to handle large rate fluctuations and periods of single-phase flow are not needed.

In some embodiments, slippage between gas and liquid phases is minimized or even eliminated in foam flow; and frictional, accelerational, and hydrostatic pressure losses may all be reduced. Accordingly, this will result in lower back pressure on the reservoir—likely allowing increases in both production rate and total recoverable reserves.

In some embodiments, chemical treatments such as hydrate inhibitors (both thermodynamic inhibitors and low-dosage hydrate inhibitors), corrosion inhibitors and drag reducing agents will be distributed more evenly around the interior circumference and along the length of the pipe by foam flow. Again, this reduces a need for pigging operations. Furthermore, foam flow is envisioned to be an effective distributor of chemicals in both continuous and intermittent processes.

In some embodiments, when foam flow passes through a hydrate formation regime within a pipeline, anti-agglomerating hydrate crystals are more likely to form in the foam matrix and continue to flow with the foam so as to avoid deposition and plugging.

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### EXAMPLE 1

This Example serves to illustrate a process and corresponding system for generating foam in situ (i.e., in-line), in accordance with some embodiments of the present invention.

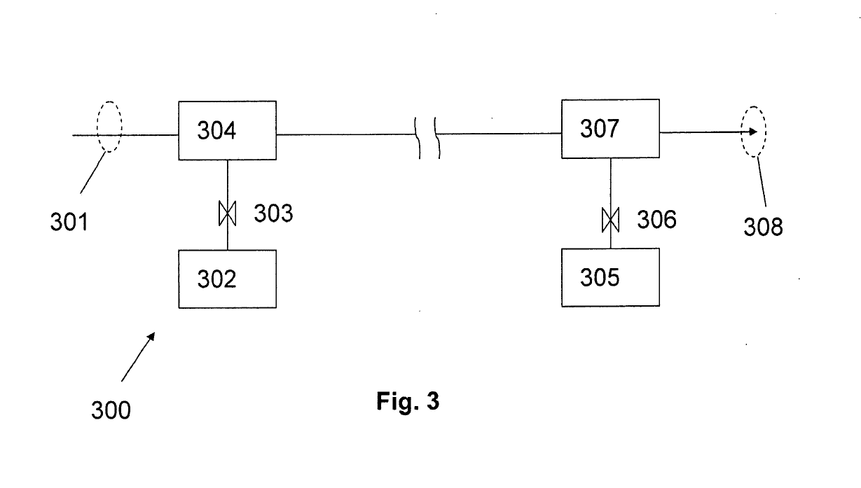

Referring to FIG. 3, depicting exemplary system 300, a gas-dominated hydrocarbon fluid flows through transport pipe 301 where, upon reaching region 304, foam is generated by a means 302. In this embodiment, the foam comprises the hydrocarbon fluid and the foam generation means is separable from the fluid flow by valve 303, so as to permit either continuous or intermittent foaming of the hydrocarbon fluid. In this embodiment, foaming is carried out in-line in region 304 using a mixing means and a foaming additive supplied from means 302. The foam then travels to region 307 where it is de-foamed by de-foaming means 305, which is separable from region 307 by valve 306. In this embodiment, the foamed hydrocarbon fluid is destabilized by addition of a de-foaming agent, dilution agent, heat, and/or mechanical force from de-foaming means 305. De-foamed hydrocarbon fluid is then collected at outlet 308.

### EXAMPLE 2

This Example serves to illustrate a process and corresponding system for generating foam in an auxiliary side stream with subsequent injection into the main transport pipeline (i.e., the main stream), in accordance with some embodiments of the present invention.

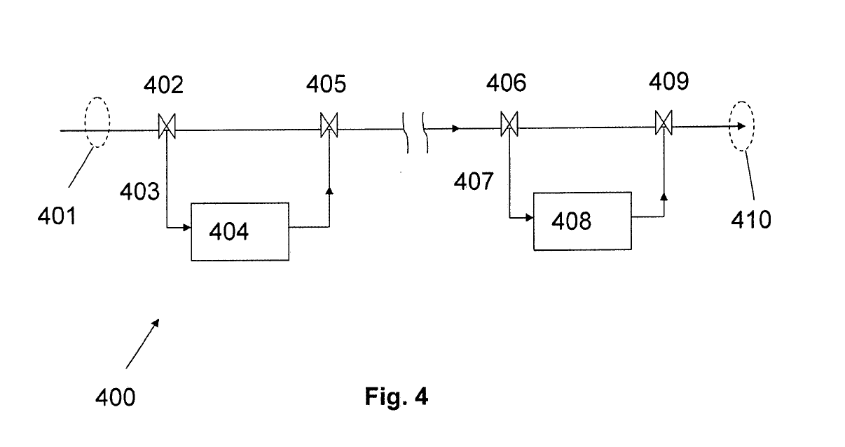

Referring to FIG. 4, depicting an alternative exemplary system 400, a gas-dominated hydrocarbon fluid flows through transport pipe 401 where, upon reaching valve 402, it is directed to auxiliary side stream 403 and foamed by a foaming means 404. In this embodiment, a foaming agent is added to the hydrocarbon fluid via foaming means 404 to create a hydrocarbon-based foam. The foam then re-enters the transport pipe 401 through valve 405 and is transported a distance through the pipe until it reaches valve 406. Upon reaching valve 406, the hydrocarbon-based foam is directed into side stream 407 and de-foamed by de-foaming means 408. In this embodiment, a de-foaming agent is introduced via de-foaming means 408. Upon being de-foamed, the hydrocarbon is directed back into the transport pipe 401 through valve 409, whereupon it is recovered from the pipe at outlet 410.

Applicants note that, alternatively, while the foaming is done in side stream 403, the de-foaming could be done in-line, as in EXAMPLE 1. Similarly, the de-foaming of EXAMPLE 1 could be carried out in an auxiliary side stream.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A method comprising the steps of:
a) generating a foam selected from the group consisting of a hydrocarbon-based foam, a water-based foam, and combinations thereof; and
b) transporting said foam a distance through a transport pipe, wherein the transport pipe is used for transporting hydrocarbon fluids.

2. The method of claim 1, wherein the step of generating a foam comprises passage of foam precursors through regions of pipe providing turbulent flow.

3. The method of claim 1, wherein the step of generating a foam comprises turbulent agitation of foam precursors.

4. The method of claim 1, wherein the step of generating a foam comprises injecting a foaming agent selected from the group consisting of surfactants, surface active agents, foamers, soaps, solid particles, and combinations thereof.

5. The method of claim 1, wherein additives are introduced during the step of generating a foam.

6. The method of claim 5, wherein the additives are selected from the group consisting of corrosion inhibitors, drag reducing agents, hydrate inhibitors, and combinations thereof.

7. The method of claim 1, wherein the step of generating a foam is done in a manner selected from the group consisting of continuous generation, intermittent generation, and combinations thereof.

8. The method of claim 1, further comprising a step of de-foaming said foam subsequent to it being transported.

9. The method of claim 1, wherein the step of generating a foam is carried out in situ.

10. The method of claim 1, further comprising a step of introducing the foam into said transport pipe.

11. A system for transporting foam through a transport pipe, the system comprising:
a) a transport pipe for transporting hydrocarbon fluids;
b) a means for generating a foam selected from the group consisting of a hydrocarbon-based foam, a water-based foam, and combinations thereof;
c) a means for transporting said foam a distance through the transport pipe; and
d) a means for destabilizing the foam subsequent to it being transported.

12. The system of claim 11, wherein the means for generating a foam comprises the addition of a foaming agent, the foaming agent being selected from the group consisting of surfactants, surface active agents, foamers, soaps, solid particles, and combinations thereof.

13. The system of claim 11, wherein the means for generating a foam comprises agitation selected from the group consisting of mechanical mixing, turbulent flow, and combinations thereof.

14. The system of claim 11, wherein the foam is generated in situ.

15. The system of claim 11 further comprising a side stream where the foam is generated, wherein the side stream is in fluid communication with the transport pipe.

16. The system of claim 15 further comprising a means for introducing said foam into the transport pipe.

17. The system of claim 11 further comprising a means of introducing additives to the foam.

18. The system of claim 17, wherein the additives are selected from the group consisting of corrosion inhibitors, drag reducing agents, hydrate inhibitors, and combinations thereof.

19. The system of claim 11, wherein the means for removing the foam comprises an addition of a de-foaming agent.

20. The system of claim 11, wherein said foam is introduced into said transport pipe only intermittently.
